(19) United States
(12) Patent Application Publication
(10) Pub. No.: US 2025/0001835 A1
(43) Pub. Date: Jan. 2, 2025

(54) METHOD AND SYSTEM FOR EVALUATING CONDITION OF PERISHABLE GOODS USING DIGITAL TWIN

(71) Applicant: Carrier Corporation, Palm Beach Gardens, FL (US)

(72) Inventors: Jeffrey Allen Leshuk, Davis, CA (US); Martin Meckesheimer, Haarlem (NL); Thijs Willem Julien Defraeye, Zurich (CH); Jörg Schemminger, Konstanz (DE)

(21) Appl. No.: 18/738,239

(22) Filed: Jun. 10, 2024

Related U.S. Application Data
(60) Provisional application No. 63/509,066, filed on Jun. 20, 2023.

(51) Int. Cl. B60H 1/32

(52) U.S. Cl. CPC B60H 1/3205; B60H 1/3232; B60H 2001/3241; B60H 2001/3245; B60H 2001/3255; B60H 2001/3282

(57) ABSTRACT

An air conditioning and refrigeration system for a container equipped with a transport refrigeration unit (TRU) is disclosed. The system comprises a variable speed fan configured with the TRU, and one or more first sensors positioned at predefined positions at a rear section of a conservation space associated with the container. The one or more first sensors are configured to monitor one or more first attributes associated with the rear section. The system further comprises a controller in communication with the one or more first sensors and the fan. The controller is configured to adjust speed of the fan and/or adjust cooling capacity of the TRU based on the monitored first attributes of the rear section, to maintain a predefined environment at the rear section or across the conservation space.

### CROSS-REFERENCE TO RELATED APPLICATION BACKGROUND

This patent application claims the benefit of U.S. Provisional Patent Application No. 63/508,947, filed on Jun. 19, 2023, which is incorporated by reference herein in its entirety.

### BACKGROUND

This invention relates to transport refrigeration units, and more particularly, to an air conditioning and refrigeration system for a container equipped with a transport refrigeration unit, and a method thereof.

Trailer refrigeration units (TRUs) may be employed in a container or trailer of vehicles to supply conditioned air within the container to maintain a conditioned environment inside the container. The storage space or environment inside the container may be conditioned based on the products being stored or transported in the container. However, the TRU may not be able to effectively monitor the environment of the entire storage space and further fail to sufficiently supply conditioned air throughout the container, especially towards a rear section of the container. As a result, the environment inside the container may not be homogeneously conditioned as per product compliance.

### SUMMARY

Disclosed herein is an air conditioning and refrigeration system for a container equipped with a transport refrigeration unit (TRU). The system comprises a variable speed fan configured with the TRU, one or more first sensors positioned at predefined positions at a rear section of a conservation space associated with the container, the one or more first sensors are configured to monitor one or more first attributes associated with the rear section, and a controller in communication with the one or more first sensors and the fan, wherein the controller is configured to adjust speed of the fan and/or adjust cooling capacity of the TRU based on the monitored first attributes of the rear section, to maintain a predefined environment at the rear section or across the conservation space.

In one or more embodiments, the system comprises one or more second sensors in communication with the controller and is configured to monitor one or more second attributes associated with one or more of return air received at a return air inlet port of the TRU and ambient air received at an ambient air inlet port of the TRU.

In one or more embodiments, the controller is configured to adjust the speed of the fan and/or cooling capacity of the TRU based on the monitored first attributes of the rear section and the monitored second attributes of the return air and/or the return air, to maintain the predefined environment across the conservation space.

In one or more embodiments, the controller is operatively coupled to a vapor compression system associated with the TRU, wherein the controller controls the operation of the vapor compression system to adjust the cooling capacity of the TRU.

In one or more embodiments, the one or more first and second attributes comprise one or more of temperature, humidity, and airflow rate, wherein the predefined environment comprises one or more of a predefined temperature range, a predefined humidity range, and a predefined airflow speed range.

In one or more embodiments, when the monitored temperature of the rear section exceeds the predefined temperature range and the monitored temperature of the return air and/or the return air is within the predefined temperature range, the controller is configured to increase the speed of the fan and/or adjust the cooling capacity of the TRU to maintain the predefined temperature range at the rear section.

In one or more embodiments, when the monitored temperature of the return air and/or the return air is within the predefined temperature range and/or the monitored temperature of the rear section is within the predefined temperature range, the controller is configured to maintain the cooling capacity of the TRU and maintain the speed of the fan to maintain the predefined temperature range across the conservation space.

In one or more embodiments, the one or more first sensors are installed over and/or within one or more boxes storing one or more products at the rear section of the container.

In one or more embodiments, the one or more first sensors are installed on an inner wall of the container at the rear section and/or disposed of in the conservation space.

In one or more embodiments, the controller is a control unit of the TRU.

In one or more embodiments, the controller is in communication with a control unit of the TRU.

In one or more embodiments, the container is a trailer associated with a vehicle, wherein the vehicle is one or more of an electric truck, a semi-electric truck, and a non-electric truck.

In one or more embodiments, the fan and the TRU are operatively coupled to an AC power source or a DC power source associated with the vehicle.

In one or more embodiments, the system comprises one or more third sensors positioned at a front section and a middle section of the storage space, wherein the one or more first sensors and the one or more third sensors monitor are configured to monitor the first attributes associated with the entire storage space.

Also described herein is a method for conditioning a conservation space of a container equipped with a transport refrigeration unit (TRU). The method comprises the steps of monitoring, by one or more first sensors, one or more first attributes associated with a rear section of the conservation space, and adjusting, by a controller, speed of a variable speed fan configured with the TRU and/or adjusting cooling capacity of the TRU based on the monitored first attributes of the rear section, to maintain a predefined environment at the rear section or across the conservation space.

In one or more embodiments, the method comprises the steps of monitoring, by one or more second sensors, one or more second attributes associated with one or more of a return air received at a return air inlet port of the TRU and ambient air received at an ambient air inlet port of the TRU, and adjusting, by the controller, speed of the fan and/or cooling capacity of the TRU based on the monitored first attributes of the rear section and the monitored second attributes of the return air and/or the ambient air, to maintain the predefined environment across the conservation space.

In one or more embodiments, the controller is operatively coupled to a vapor compression system associated with the TRU, wherein the method comprises the step of controlling, by the controller, the operation of the vapor compression system to adjust the cooling capacity of the TRU.

In one or more embodiments, the one or more first and second attributes comprise one or more of temperature, humidity, and airflow rate, wherein the predefined environment comprises one or more of a predefined temperature range, a predefined humidity range, and a predefined airflow speed range.

In one or more embodiments, the method comprises the steps of monitoring, by one or more third sensors positioned at a front section and a middle section of the storage space, the first attributes associated with the front section and the middle section of the storage space.

In one or more embodiments, when the monitored temperature of the rear section exceeds the predefined temperature range and the monitored temperature of the return air and/or the ambient air is within the predefined temperature range, the method comprises the steps of increasing the speed of the fan and/or adjusting the cooling capacity of the TRU to maintain the predefined temperature range at the rear section.

In one or more embodiments, when the monitored temperature of the return air and/or the ambient air is within the predefined temperature range and/or the monitored temperature of the rear section is within the predefined temperature range, the method comprises the steps of maintaining the cooling capacity of the TRU and maintaining the speed of the fan to maintain the predefined temperature range across the conservation space.

The foregoing summary is illustrative only and is not intended to be in any way limiting. In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary representations of an air conditioning and refrigeration system “system” for a container equipped with a transport refrigeration unit (TRU), in accordance with one or more embodiments of the subject disclosure.

FIG. 2 illustrates an exemplary block diagram of the system of FIGS. 1A and 1B, in accordance with one or more embodiments of the subject disclosure.

FIG. 3A illustrates exemplary steps involved in a method for conditioning a conservation space of a container equipped with TRU, in accordance with one or more embodiments of the subject disclosure.

FIG. 4A 3B illustrates an exemplary flow diagram depicting the control strategy of the controller of FIGS. 1A to 2, in accordance with one or more embodiments of the subject disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components of this invention, described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components.

Trailer refrigeration units (TRUs) may be employed in a container or trailer of vehicles to supply conditioned air within the container for maintaining a conditioned environment inside the storage space of the container. Various products including but not limited to pharmaceutical and nutraceutical products, and perishable items such as foods and beverages may be stored and transported in containers equipped with the TRU. These products are to be maintained at a specific temperature and/or humidity while transportation to keep them in a healthy condition and comply with product compliance regulations. Accordingly, based on the products being stored or transported in the container, the cooling capacity of the TRU may be adjusted to supply conditioned air within the storage space for maintaining the conditioned environment inside the storage space. However, the TRU may not be able to effectively monitor the environment of the entire storage space and further fail to sufficiently supply conditioned air throughout the storage space, especially towards a rear section of the container. As a result, the environment inside the container may not be homogeneously conditioned as per product compliance regulations, which may affect the stored products. There is therefore a need to maintain a homogenous and conditioned environment throughout the storage space in the container as per product compliance regulations.

This invention overcomes the above-mentioned shortcomings and limitations associated with the existing containers equipped with TRUs, by providing an improved, automated, cost-effective, and efficient air conditioning and refrigeration system and method for containers equipped with a TRU, which effectively monitors the environment of the entire storage space of the container and further maintains a homogenous and conditioned environment throughout the storage space as well as at the rear section of the container.

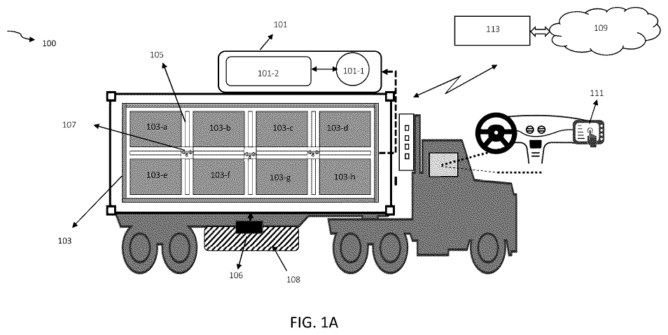

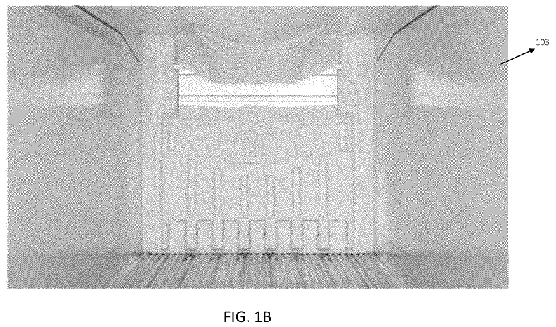

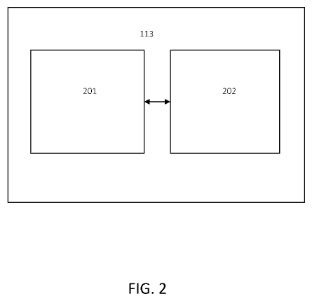

Referring to FIGS. 1A to 2, an air conditioning and refrigeration system “system” 100 for a container (trailer) 102 equipped with a transport refrigeration unit (TRU) 104 is disclosed, which may be configured to maintain a predefined homogenous environment across an entire enclosed (storage or conservation) space 106, including a rear section 106-1, associated with the container/trailer 102. Various products including but not limited to pharmaceutical and nutraceutical products, and perishable items such as foods and beverages may be stored and transported in container/trailer 102. The system 100 may keep these products may be maintained at a specific temperature and/or humidity while transportation to keep them in a healthy condition and comply with product compliance regulations.

The TRU 104 may be installed on the container/trailer 102 associated with one or more vehicles including one or more of an electric truck, a semi-electric truck, and a non-electric truck such that the TRU 104 remains fluidically connected to the ambient and further gets fluidically connected to the storage space 106 of the container/trailer 102. The TRU 104 may include a housing having a return air inlet port 104-1, an ambient air inlet port 104-2, and an air outlet port 104-3. The return air inlet port 104-1 may be fluidically connected to storage space 106 to receive return air and the ambient air inlet port 104-2 may be fluidically connected to ambient to receive ambient (outside) air. Further, the air outlet port 104-3 of the TRU 104 may be fluidically connected to the storage space 106 of the container/trailer 102.

In one or more embodiments, based on the predetermined environment to be maintained in the storage space 106 or as per product compliance regulations, the TRU 104 may be operated to ingress the return air via the return inlet port 104-1 and/or ambient air via the ambient air inlet port 104-2 and degrees air (also referred to as exhaust air) into the storage space 106 (at a higher or lower temperature compared to the ingressed air (ambient air and/or return air) via the outlet port 104-3. For instance, the exhaust air from the TRU 104 may be warmer or hotter than the ingressed air (ambient air and/or return air) such that the TRU 104 may be employed to supply warm or hot air in the storage space 106 of the container/trailer 102 to maintain the predetermined environment. In another instance, the exhaust air from the TRU 104 may be cooler than the received air such that the TRU 104 may be employed to supply cool air in the container 102 to maintain the predetermined environment. The detailed construction and operation of the TRU 104 have been explained in subsequent paragraphs.

The system 100 may include a variable-speed fan 108 configured with or within the TRU 104, which may control the ingress of the return airflow into the TRU 104 via the return inlet port 104-1 or ambient airflow into the TRU 104 via the ambient inlet port 104-2 and further control the flow of conditioned exhaust air into the storage space 106 of the container 102 via the outlet port 104-3. The system 100 may further include one or more first sensors 110-1 positioned at predefined positions at the rear section 106-1 of the storage (conservation) space 106 associated with the container 102. The first sensors 110-1 may be positioned at the bottom, middle and upper regions of the rear section 106-1 of the storage space 106. The first sensors 110-1 may be configured to monitor one or more first attributes associated with the rear section 106-1 of the storage space 106. In addition, in some embodiments, additional sensors may be positioned throughout the conservation space 106. For instance, one or more second sensors 110-2 such as a return air sensor (RAT) may be positioned within the container 102 or TRU 104 at the return air inlet port 104-1 of the TRU 104 to monitor second attributes associated with the return air being received by the TRU 104 and a supply air temperature (SAT) (not shown) may be positioned outside of the container 102 or TRU 104 at the ambient air inlet port 104-2 to monitor second attributes associated with the outside (ambient) air being received by the TRU 104. Further, third sensors 110-3 may be positioned at the front and/or middle sections 106-2, 106-3 of the storage space 106, such that the first sensors 110-1 and the third sensors 110-3 may effectively monitor the first attributes associated with the entire storage space 106. The third sensors 110-3 may be positioned at the bottom, middle and upper regions of the front section and middle section of the storage space 106. As the third sensors may 110-3 not be effective in monitoring the entire storage space 106, however, it is to be appreciated that the first sensors 110-1 may enable the system 110 to monitor the environment of the entire storage space 106. Moreover, the monitoring of control temperature (i.e., the temperature of the return air or outside/ambient air) by second sensors 110-2 may enable the system 100 to restrict overcooling or overheating of the front or middle sections 106-2, 106-3 of the storage space 106 while maintaining the predetermined environment at the rear section 106-1 of the storage space 106.

In one or more embodiments, the first and second attributes may include one or more of temperature, humidity, and airflow rate, but is not limited to the like. Further, the predefined environment may include one or more of a predefined temperature range, a predefined humidity range, and a predefined airflow speed range, but is not limited to the like, to be maintained in the storage space 106.

The system 100 may further include a controller 202 in communication with the first sensors 110-1, the second sensors 110-2, the third sensors 110-3, a vapor compression system 112 of the TRU 104, and the variable speed fan 108. In one or more embodiments, the controller 202 may be a control unit of the TRU 104. In other embodiments, the controller 202 may be in communication with a control unit of the TRU 104. The first sensors 110-1, the second sensors 110-2, and the third sensors 110-3 may be wireless sensors and/or wired sensors that may be connected to the controller 202 by wired or wireless media. The controller 202 may be configured to adjust the speed of the fan 108 and/or cooling capacity of the TRU 104 based on the monitored first attributes of the rear section 106-1 and the monitored second attributes (or control temperature) of the return air and/or the outside (ambient) air, to maintain the predefined environment across the entire storage space 106.

In one or more embodiments, when the monitored temperature of the rear section 106-1 exceeds the predefined temperature range and the control temperature (temperature of the return air and/or the ambient air) is detected to be within the predefined temperature range, the controller 202 may be configured to increase the speed of the fan 108 and/or operate the vapor compression system 112 to adjust the cooling capacity of the TRU 104 in order to maintain the predefined temperature range at the rear section 106-1, thereby creating a homogenous predetermined environment in the entire storage space 106.

In other embodiments, when the control temperature (temperature of the return air and/or the ambient air) is detected to be within the predefined temperature range and/or the monitored temperature of the rear section 106-1 is detected to be within the predefined temperature range, the controller 202 may be configured to maintain the same cooling capacity of the TRU 104 and further maintain the speed of the fan 108 to maintain the predefined temperature range across the storage space 106.

In an example, the predefined temperature range to be maintained in the rear section 106-1 of the storage space 106 may be set as 5° C.±2° C., where the set point temperature may be 5° C. with a tolerance of 2° C. Further, the control temperature detected by the second sensors 110-2 may be 4° C. Furthermore, if the temperature of the rear section 106-1 is detected (by the first sensors 110-1) to be 5° C., controller 202 may identify a gap of 3° C. between the detected temperature and the predefined temperature range of the rear section 106-1 as the tolerance is ±2° C. Accordingly, the controller 202 may increase the speed of the fan 108 and/or operate the vapor compression system 112 to increase the cooling capacity of the TRU 104 in order to maintain the predefined temperature range (5° C.) in the rear section 106-1.

Referring to FIG. 2, the controller 202 can include a processor 202-1 coupled to a memory 202-2 storing instructions executable by the processor 202-1 to enable the controller 202 to perform one or more designated operations. The memory 202-2 of the controller 202 may contain predefined values for various operating parameters or attributes to be maintained within the container 102 or the space 106. The parameters and attributes may include but are not limited to, temperature set points for various locations within the container 102 or the space 106, pressure limits, current limits, engine speed limits, and any variety of other desired operating parameters or limits with the TRU 104.

The controller 202 may control the operation of the vapor compression system 112 of the TRU 104 to adjust the cooling capacity of the TRU 104 based on the predetermined environment to be maintained in the storage space 106. In one or more embodiments, the vapor compression system 112 may comprise a compressor 204, a condenser 206 configured downstream of the compressor 204, an expansion device 208 configured downstream of the condenser 206, and an evaporator 210 configured downstream of the expansion device 208, enclosed within the housing of the TRU 104 having the inlet port 104-1 and the outlet port 105-2. In addition, an outlet of the compressor 204 may be fluidically connected to the condenser 206. In one or more embodiments, the compressor 204 may be a variable-speed scroll compressor, however, other compressors such as reciprocating or screw compressors are possible without limiting the scope of the disclosure. A motor (not shown) may be used to drive the compressor 204. For example, a motor can be an integrated electric drive motor driven by a synchronous generator, a commercial power service an external power generation system (e.g., shipboard), a generator or the like. The compressor 204 may also be a multi-stage compression device.

In one or more embodiments, referring back to FIGS. 1A and 1B, the TRU 104 may be coupled to the front end (F) of the container/trailer 102. The air outlet port 104-3 of the TRU may be in fluidic communication with the storage space 106 of the container/trailer 102, the return inlet port 104-1 may be in fluidic communication with the storage space 106, and the ambient inlet port 104-2 may be in fluidic communication with ambient. Further, the trailer 102 may be coupled to a rear end of a cab or truck 114 such that a gap remains therebetween. The TRU 104 may be coupled to the front end (F) of the container/trailer 102 in the gap area between the cab 114 and container/trailer 102. Alternatively, in one or more embodiments, the TRU 104 may be coupled to a prescribed position on a side or more than one side of the container/trailer 102. Moreover, a plurality of TRUS 104 can be coupled to a single container/trailer 102. Alternatively, a single TRU 104 can be coupled to a plurality of container/trailers 102.

In one or more embodiments, referring back to FIG. 2, in a cooling mode or cooling cycle (i.e., when the cooling capacity of the TRU 104 is to be increased), the TRU 104 may circulate the refrigerant from the compressor 204 to the condenser 206, through the expansion device 208 and the evaporator 210, and then return to the compressor 204, high-temperature, high-pressure refrigerant vapor exiting the outlet of the compressor 204 may move to the condenser 206 that may include a plurality of condenser coils, which may receive air blown by a condenser 206 fan 108 (not shown). The condenser 206 may facilitate heat exchange between the refrigerant flowing within the condenser 206 coils and the received air to remove latent heat through the condenser 206, which may condense the refrigerant to a high-pressure/high-temperature liquid within the condenser 206 coils. The high-pressure/high-temperature liquid refrigerant may flow to a receiver that may provide storage for excess liquid refrigerant during low-temperature operations. Further, from the receiver, the refrigerant may flow to a filter drier which may keep the refrigerant clean and dry.

The TRU 104 or vapor compression system 112 may further include an economizer 212 fluidically configured between the compressor 204, the receiver, the evaporator 210, and the condenser 206. In one or more embodiments, the expansion device 208 may be an electronic evaporator expansion valve (EVXV). The economizer 212 may increase the refrigerant subcooling. When the economizer 212 is active, an injection solenoid valve associated with the economizer 212 may open to allow refrigerant to pass through an auxiliary expansion valve having a sensing bulb located upstream of an intermediate inlet port of the compressor 204. The injection solenoid valve may be controlled, responsive to the temperature measured at the bulb, and serve to expand and cool the refrigerant that proceeds into an economizer counter-flow heat exchanger that may additionally sub-cool the liquid refrigerant.

The refrigerant may flow from the economizer heat exchanger of the economizer 212 to the EVXV 208. As the liquid refrigerant passes through the orifice of the EVXV 208, at least some of the liquid refrigerant may vaporize. The vaporized refrigerant may then enter the evaporator 210 via the distributor and then flow through the evaporator coils of the evaporator 210. The evaporator 210 may absorb heat from the air (e.g., return air returning from the storage space 106 or the outside/ambient air) to vaporize some or all of the remaining liquid refrigerant in the evaporator 210. The air may preferably be drawn or pushed across the evaporator coils by the fan 108. The refrigerant vapor may be drawn from the evaporator 210 through a suction service valve back into the compressor 204 via an accumulator that may store any excess refrigerant. Further, a heat exchanger may be additionally configured in the TRU 104 to facilitate heat transfer from a warm refrigerant supplied by the condenser 206 or the sub-cooled liquid from the economizer's heat exchanger to the cold refrigerant supplied by the evaporator 210 during the cooling cycle. Further, the variable speed fan 108 may enable (increase or decrease) the flow of the air (ambient air and/or return air) through the TRU 104 while passing the air across the cold refrigerant-carrying evaporator coils to cool the air and further supply the cool exhaust air into the storage space 106 via the outlet port 104-3, thereby maintaining the predetermined environment within the entire storage space 106 of the container/trailer 102.

In one or more embodiments, the controller 202 can include a communication module 202-3 that can operatively couple the controller 202 to the first sensors 110-1, the second sensors 110-2, the third sensors 110-3, the vapor compression system 112 of the TRU 104, and the variable speed fan 108, and further enable the controller 202 to receive temperature inputs, pressure inputs, and humidity levels from various points in the storage space 106. In addition, the controller 202 can include an actuator, drive circuit, and relays to receive signals or current from the controller 202 and in turn control various internal components of the TRU 104, the fan 108, the vapor compression system 112 as well as external or peripheral devices in the TRU 104.

In one or more embodiments, the fan 108 and the TRU 104 may be operatively coupled to an AC power source or a DC power source (collectively designated as 116, herein) associated with the vehicle. The controller 202 may control the operation of the fan 108 and the vapor compression system 112 of the TRU 104 based on the available electrical power while maintaining the predetermined environment in the storage space 106. In one or more embodiments, when the controller 202 calculates the available electrical power to go below a predefined level after a predefined time, which may affect maintaining the predetermined environment in the storage space 106 after the predefined time, the controller 202 may accordingly transmit an alert signal to mobile devices associated with a user of the vehicle or a human-machine interface (HMI) installed in the vehicle. The alert signal may be indicative of a request for charging the power source of the vehicle and/or electrically connecting the TRU 104 and the system to an external power source.

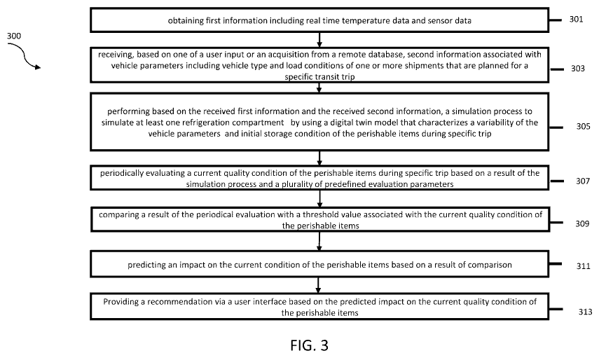

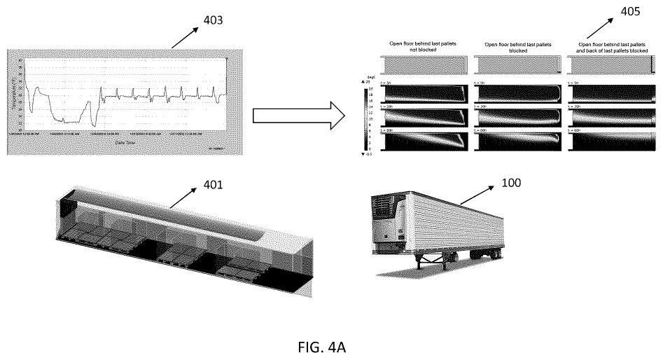

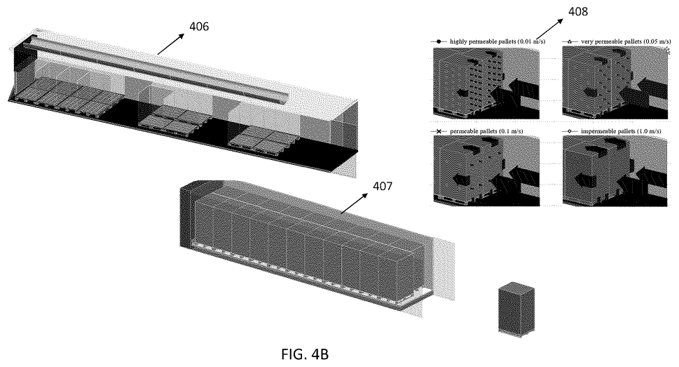

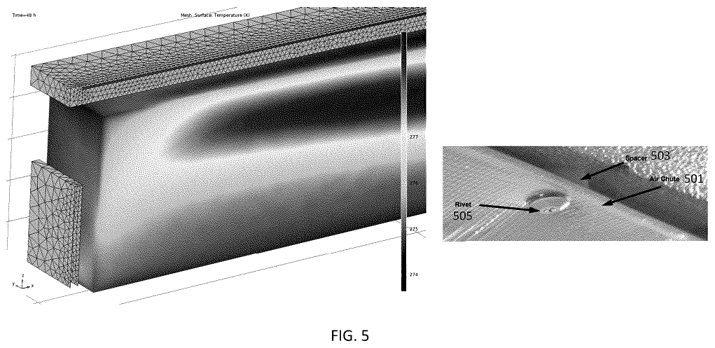

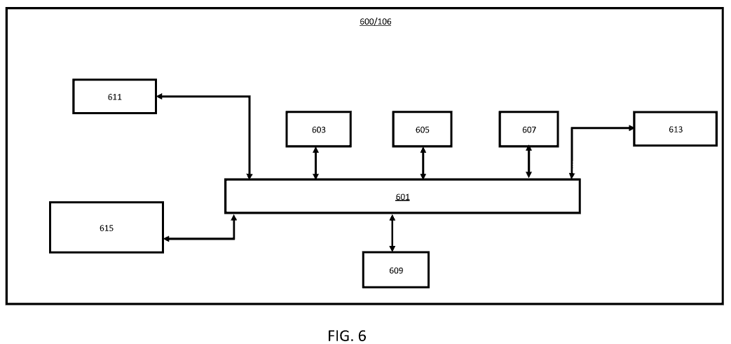

Referring to FIG. 3A, method 300 for conditioning a storage space of a container/trailer equipped with a transport refrigeration unit (TRU) is disclosed. Further, referring to FIG. 3B, an exemplary flow diagram depicting the control strategy of the controller is disclosed. Method 300 may involve the first sensors 110-1, the second sensors 110-2, the third sensors 110-3, the vapor compression system 112 of the TRU 104, and the variable speed fan 108. Method 300 may include step 302 of monitoring, by the first sensors, one or more first attributes associated with a rear section of the storage space. Further, method 300 may include step 304 of monitoring, by the second sensors, one or more second attributes associated with one or more of the return air, and the ambient air received at a return air inlet port and an ambient air inlet port, respectively, of the TRU.

In one or more embodiments, method 300 may include the steps of positioning one or more third sensors at a front section and a middle section of the storage space. The third sensors may be configured to monitor the first attributes associated with the front section and the middle section of the storage space.

Method 300 may further include step 306 of adjusting, by the controller, the speed of the fan and/or cooling capacity of the TRU based on the monitored first attributes of the rear section and the monitored second attributes of the return air and/or the ambient air, to maintain the predefined environment across the storage space. In one or more embodiments, the method of adjusting the cooling capacity of the TRU may comprise the step of controlling, by the controller, the operation of the vapor compression system associated with the TRU to adjust the cooling capacity of the TRU.

In one or more embodiments, when the control temperature (temperature of the return air and/or the ambient air) is detected to be within the predefined temperature range, at step 308, the controller may maintain the same cooling capacity in the TRU and further maintain the speed of the fan to maintain the predefined temperature range across the storage space.

In one or more embodiments, when the control temperature (temperature of the return air and/or the ambient air) is detected to be within the predefined temperature range and the monitored temperature of the rear section is also detected to be within the predefined temperature range, at step 310, the controller may maintain the same cooling capacity of the TRU and further maintain the same speed of the fan to maintain the predefined temperature range across the storage space.

In one or more embodiments, when the monitored temperature of the rear section exceeds the predefined temperature range and the control temperature (temperature of the return air and/or the ambient air) is detected to be within the predefined temperature range, at step 306, the controller may increase the speed of the fan and adjust the cooling capacity of the TRU to maintain the predefined temperature range at the rear section of the storage space.

Thus, this invention overcomes the drawbacks, and limitations associated with the existing containers/trailers equipped with TRU, by providing an improved, automated, cost-effective, and efficient air conditioning and refrigeration system for containers equipped with a TRU. The invention effectively monitors the environment of the entire storage space of the container including the rear section of the storage space and further maintains a homogenous and conditioned environment throughout the storage space, thereby keeping the stored products healthy and meeting the product compliance regulations.

The use of the term “homogenous environment” refers to a conditioned environment within the storage space 106 where the temperature, humidity, and/or other environmental conditions associated with the storage space 106 may be a numerical value having a variation less than or equal to ±10% of the numerical value, expressly including any narrow range within the given range of the numerical value as well as the exact numerical value. For example, a temperature of “about” 30° C. refers to a temperature from 27° C. to 33° C., but also expressly includes any narrower range of temperature or even a single temperature within that range, including, for example, a temperature of exactly 30° C.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. An air conditioning and refrigeration system for a container equipped with a transport refrigeration unit (TRU), the system comprising:
a variable speed fan configured with the TRU;
one or more first sensors positioned at predefined positions at a rear section of a conservation space associated with the container, the one or more first sensors are configured to monitor one or more first attributes associated with the rear section; and
a controller in communication with the one or more first sensors and the fan, wherein the controller is configured to adjust speed of the fan and/or adjust cooling capacity of the TRU based on the monitored first attributes of the rear section, to maintain a predefined environment at the rear section or across the conservation space.

2. The system of claim 1, wherein the system comprises one or more second sensors in communication with the controller and configured to monitor one or more second attributes associated with one or more of return air received at a return air inlet port of the TRU and ambient air received at an ambient air inlet port of the TRU,
wherein the controller is configured to adjust the speed of the fan and/or cooling capacity of the TRU based on the monitored first attributes of the rear section and the monitored second attributes of the return air and/or the ambient air, to maintain the predefined environment across the conservation space.

3. The system of claim 1, wherein the controller is operatively coupled to a vapor compression system associated with the TRU, wherein the controller controls the operation of the vapor compression system to adjust the cooling capacity of the TRU.

4. The system of claim 1, wherein the one or more first and second attributes comprise one or more of temperature, humidity, and airflow rate, wherein the predefined environment comprises one or more of a predefined temperature range, a predefined humidity range, and a predefined airflow speed range.

5. The system of claim 1, wherein when the monitored temperature of the rear section exceeds the predefined temperature range and the monitored temperature of the return air and/or the ambient air is within the predefined temperature range, the controller is configured to increase the speed of the fan and/or adjust the cooling capacity of the TRU to maintain the predefined temperature range at the rear section.

6. The system of claim 1, wherein when the monitored temperature of the return air and/or the ambient air is within the predefined temperature range and/or the monitored temperature of the rear section is within the predefined temperature range, the controller is configured to maintain the cooling capacity of the TRU and maintain the speed of the fan to maintain the predefined temperature range across the conservation space.

7. The system of claim 1, wherein the one or more first sensors are installed over and/or within one or more boxes storing one or more products at the rear section of the container.

8. The system of claim 1, wherein the one or more first sensors are installed on an inner wall of the container at the rear section and/or disposed of in the conservation space.

9. The system of claim 1, wherein the controller is a control unit of the TRU.

10. The system of claim 1, wherein the controller is in communication with a control unit of the TRU.

11. The system of claim 1, wherein the container is a trailer associated with a vehicle, wherein the vehicle is one or more of an electric truck, a semi-electric truck, and a non-electric truck.

12. The system of claim 1, wherein the fan and the TRU are operatively coupled to an AC power source or a DC power source associated with the vehicle.

13. The system of claim 1, wherein the system comprises one or more third sensors positioned at a front section and a middle section of the storage space, wherein the one or more first sensors and the one or more third sensors monitor are configured to monitor the first attributes associated with the entire storage space.

14. A method for conditioning a conservation space of a container equipped with a transport refrigeration unit (TRU), the method comprising the steps of:
monitoring, by one or more first sensors, one or more first attributes associated with a rear section of the conservation space; and
adjusting, by a controller, speed of a variable speed fan configured with the TRU and/or adjusting cooling capacity of the TRU based on the monitored first attributes of the rear section, to maintain a predefined environment at the rear section or across the conservation space.

15. The method of claim 14, wherein the method comprises the steps of:
monitoring, by one or more second sensors, one or more second attributes associated with one or more of a return air received at a return air inlet port of the TRU, and ambient air received at an ambient air inlet port of the TRU; and
adjusting, by the controller, speed of the fan and/or cooling capacity of the TRU based on the monitored first attributes of the rear section and the monitored second attributes of the return air and/or the ambient air, to maintain the predefined environment across the conservation space.

16. The method of claim 14, wherein the controller is operatively coupled to a vapor compression system associated with the TRU, wherein the method comprises the step of controlling, by the controller, the operation of the vapor compression system to adjust the cooling capacity of the TRU.

17. The method of claim 14, wherein the method comprises the steps of monitoring, by one or more third sensors positioned at a front section and a middle section of the storage space, the first attributes associated with the front section and the middle section of the storage space.

18. The method of claim 14, wherein the one or more first and second attributes comprise one or more of temperature, humidity, and airflow rate, wherein the predefined environment comprises one or more of a predefined temperature range, a predefined humidity range, and a predefined airflow speed range.

19. The method of claim 14, wherein when the monitored temperature of the rear section exceeds the predefined temperature range and the monitored temperature of the return air and/or the ambient air is within the predefined temperature range, the method comprises the steps of increasing the speed of the fan and/or adjusting the cooling capacity of the TRU to maintain the predefined temperature range at the rear section.

20. The method of claim 14, wherein when the monitored temperature of the return air and/or the ambient air is within the predefined temperature range and/or the monitored temperature of the rear section is within the predefined temperature range, the method comprises the steps of maintaining the cooling capacity of the TRU and maintaining the speed of the fan to maintain the predefined temperature range across the conservation space.
